(19) United States
(12) Patent Application Publication
(10) Pub. No.: US 2005/0264707 A1
(43) Pub. Date: Dec. 1, 2005

(54) Image forming apparatus having two-stage structure and projection TV set having the same

(75) Inventors: Sung-tae Kim, Seoul (KR); Jeong-ho Nho, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/129,419

(22) Filed: May 16, 2005

(30) Foreign Application Priority Data
May 14, 2004 (KR) 10-2004-0034285

(51) Int. Cl. H04N 9/31

(52) U.S. Cl. 348/744; 348/743; 348/771

(57) ABSTRACT

An image forming apparatus and a projection TV set having the same are provided. The image forming apparatus includes an illumination system including a light source; a color separator separating beams irradiated from the light source into separate colored beams; at least one light-path converter bending the beam irradiated from the light source upwards; and a display device processing the incident beam in response to an input signal and forming a color image; and a projection system enlarging and projecting the color image formed by the illumination system onto a screen, wherein an optical axis of the beam emitted from the light source and an optical axis of the beam reflected by the display device are disposed by the at least one light-path converter at different heights such that the illumination system and the projection system extend to be narrow in a widthwise direction and long in a lengthwise direction.

### CROSS-REFERENCE TO RELATED PATENT APPLICATIONS

This application claims the benefit of Korean Patent Application No. 10-2004-0034285, filed on May 14, 2004, in the Korean Intellectual Property Office, the disclosure of which is incorporated herein in its entirety by reference.

### BACKGROUND OF THE INVENTION

1. Field of the Invention

The present invention relates to an image forming apparatus having a two-stage structure in which an illumination system and a projection system are disposed at different heights to be suitably mounted in a stand-shaped cabinet, and a projection TV set having the image forming apparatus.

2. Description of the Related Art

A projection system is largely classified into a three-panel projection system or a single-panel projection system depending on the number of display devices that perform on-off control of light emitted from a light source in units of pixels. The light source is a high-powered lamp which produces a color image. In the single-panel projection system, the structure of the optical system can be reduced, in comparison to the three-panel projection system, but white light is separated into red (R), green (G), and blue (B) colors using a sequential method. Thus, the photoefficiency of the single-panel projection system is ⅓ the photoefficiency of the three-panel projection system. Thus, efforts for increasing photoefficiency of the single-panel projection system have been made.

In a conventional single-panel projection system, a beam irradiated from a white light source is separated into R, G, and B color beams using a color filter, and each color beam is sequentially transferred to a display device. The display device is operated sequentially, in the order of the colors received, so as to form an image.

As shown in FIG. 1A, the conventional single-panel projection system includes a light source 10; a color wheel 15 through which a beam emitted from the light source 10 passes sequentially in the order of colors; an integrator 17 which shapes the beam that has passed through the color wheel 15; a total reflection prism 25 which totally reflects the beam that has passed through the integrator 17; and a display device 27 which receives the beam reflected by the total reflection prism 25, processes the beam according to an input image signal, and forms a color image. The system further includes a projection system 30 which enlarges and projects the color image formed by the display device 27 onto a screen.

An ultraviolet interception filter 12 is disposed between the light source 10 and the color wheel 15, and a lens group 20, which condenses the beam that has passed through the integrator 17, is disposed on a light path between the integrator 17 and the total reflection prism 25.

The total reflection prism 25 includes an incidence prism 25a which totally reflects the beam emitted from the light source 10 onto the display device 27; and an emission prism 25b which transmits the beam reflected by the display device 27 to the projection system 30.

The entire device, from the light source 10 to the projection system 30, has a horizontal structure with a width which is, relative to its height, very large.

FIG. 1B shows a projection TV set having a cabinet 40 which contains a screen unit 35 on which a screen S is mounted. Inside the cabinet 40, an image forming apparatus is installed. Reference numeral 42 denotes a decoration cabinet.

The image forming apparatus having the horizontal structure shown in FIG. 1A is advantageous to be installed in the cabinet 40 extending in a horizontal direction, as shown in FIG. 1B. The conventional image forming apparatus is suitable for a projection TV set having a shape similar to a desktop monitor.

However, customers desire projection TV sets having a variety of designs. Thus, in order to change the appearance of the projection TV set, the structure of the image forming apparatus needs to be changed.

### SUMMARY OF THE INVENTION

The present invention provides an image forming apparatus that can be suitably installed in a cabinet having a stand or pillar shape extending vertically, and a projection TV set having the same.

Consistent with an aspect of the present invention, there is provided an image forming apparatus including: an illumination system including: a light source; a color separator separating beams irradiated from the light source into separate colored beams; at least one light-path converter bending the beam irradiated from the light source upwards; and a display device processing the incident beam in response to an input signal and forming a color image; and a projection system enlarging and projecting the color image formed by the illumination system onto a screen, wherein an optical axis of a beam emitted from the light source and an optical axis of a beam reflected by the display device are disposed by the at least one light-path converter at different heights such that the illumination system and the projection system extend to be narrow in a widthwise direction and long in a lengthwise direction.

Consistent with another aspect of the present invention, there is provided a projection TV set including a screen unit and a cabinet having an image forming apparatus, wherein the image forming apparatus disposed in a vertical direction is installed in the cabinet and the cabinet has a smaller width than the screen unit and a pillar shape extending vertically.

### BRIEF DESCRIPTION OF THE DRAWINGS

The above aspects and advantages of the present invention will become more apparent by describing in detail exemplary embodiments thereof with reference to the attached drawings in which:

FIG. 1A is a schematic diagram of a conventional image forming apparatus;

FIG. 1B shows the appearance of a projection TV set having the conventional image forming apparatus;

FIG. 2 shows the appearance of a projection TV set having an image forming apparatus consistent with an exemplary embodiment of the present invention;

FIG. 3 is a schematic diagram of a structure of an image forming apparatus consistent with another exemplary embodiment of the present invention;

FIG. 4 is a right-side view of FIG. 3;

FIG. 5 shows the structure and coordinate system of a deformable micromirror device (DMD) used in the image forming apparatus consistent with another exemplary embodiment of the present invention;

FIG. 6A shows a light path of a beam reflected upwards by a first light-path converter used in the image forming apparatus shown in FIG. 3;

FIG. 6B is a schematic diagram of the gradient of the first light-path converter, at which a beam is reflected upwards by the first light-path converter used in the image forming apparatus shown in FIG. 3;

FIG. 7A is a schematic diagram of the arrangement of a second light-path converter and a display device which allows a beam to be incident on the display device at a predetermined angle after reflecting from the second light-path converter used in the image forming apparatus shown in FIG. 3; and

FIGS. 7B, 7C, and 7D are schematic diagrams of the gradient of the second light-path converter at which a beam incident on the second light-path converter, used in the image forming apparatus shown in FIG. 3, is reflected at a predetermined angle.

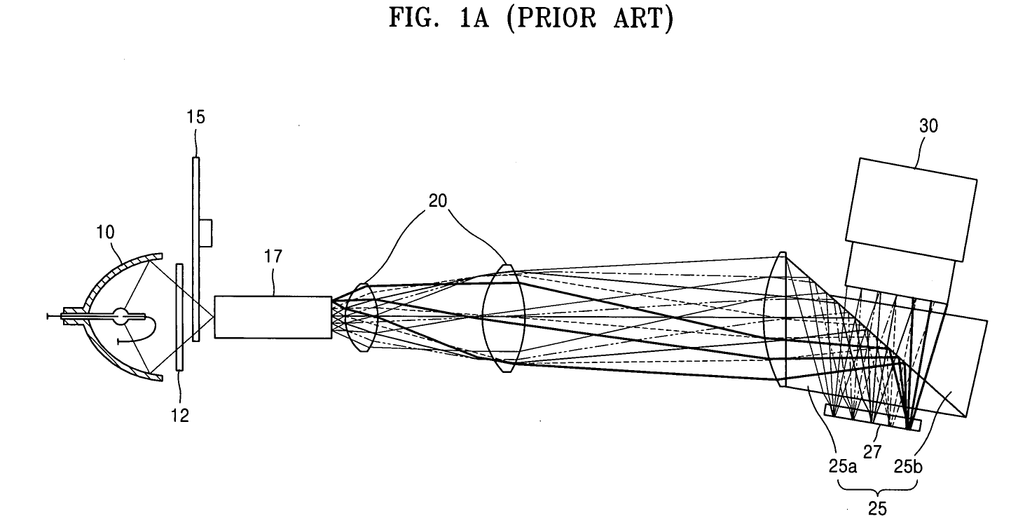

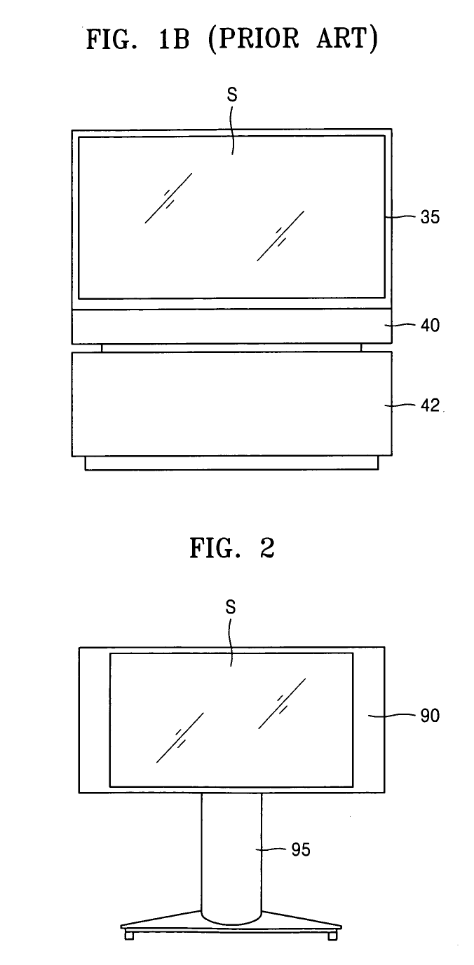

### DETAILED DESCRIPTION OF THE INVENTION

FIG. 2 shows a projection TV set having an image forming apparatus consistent with an exemplary embodiment of the present invention. The projection TV set of FIG. 2 includes a screen unit 90 having a screen S; and a cabinet 95 having a stand or pillar shape extending vertically disposed under the screen unit 90.

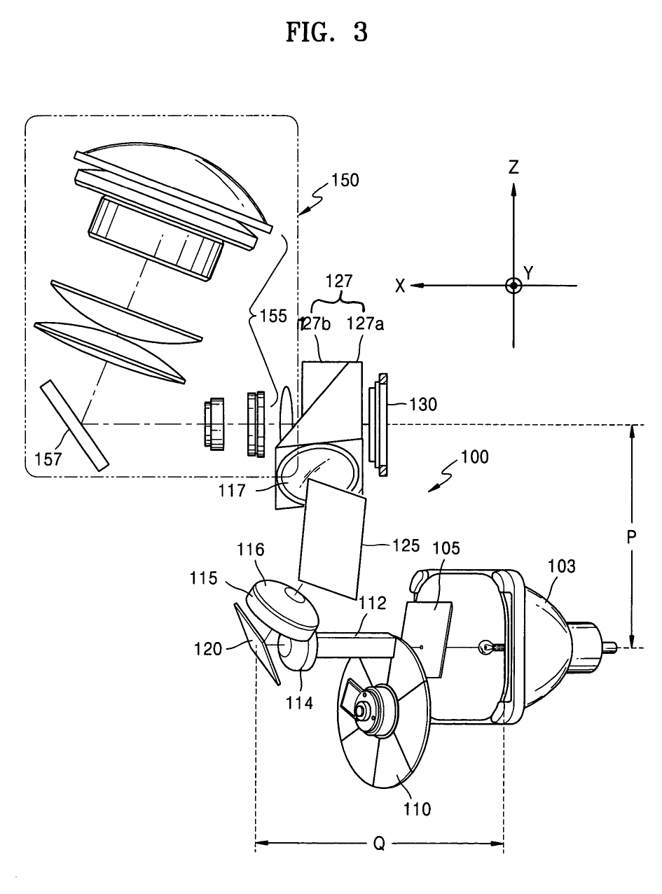

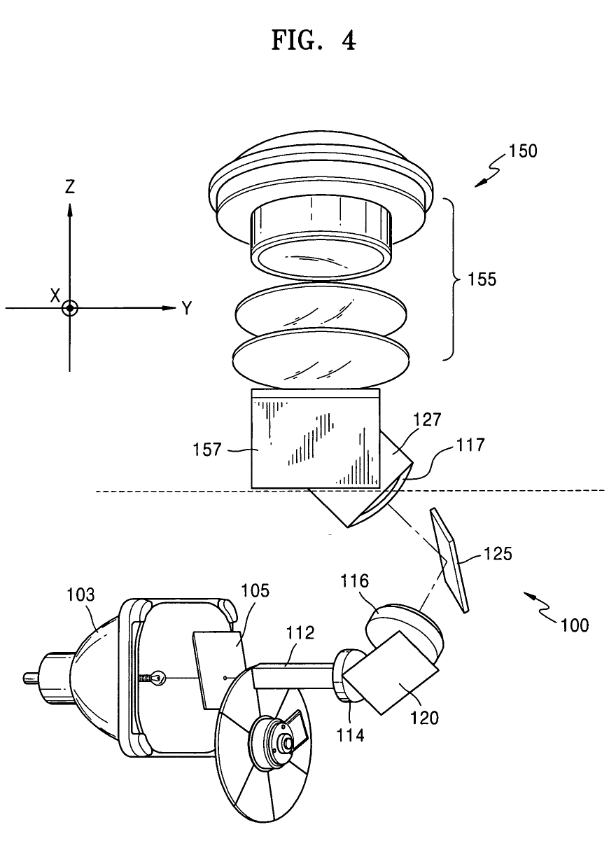

FIGS. 3 and 4 are schematic diagrams of an image forming apparatus consistent with another exemplary embodiment of the present invention. The image forming apparatus of FIGS. 3 and 4 includes an illumination system 100 which radiates a beam and forms a color image; and a projection system 150 which enlarges and projects the color image onto a screen S. The illumination system 100 and the projection system 150 are disposed at different heights extending vertically.

Also, the illumination system 100 and the projection system 150 are installed in the cabinet 95. The present invention is an improved structure relative to a prior-art structure in which the illumination system 100 and the projection system 150 are suitably installed in the cabinet 95 having a stand shape, as shown in FIG. 2.

The illumination system 100 includes a light source 103 which radiates a beam; a color separator 110 which separates the beam irradiated from the light source 103 into separate colors; and a display device 130 which processes the color beam that has passed through the color separator 110 in response to an input signal and forms a color image. In addition, in order to arrange the illumination system 100 to extend vertically, the illumination system 100 further includes at least one light-path converter which bends the beam irradiated from the light source 103 upwards. The projection system 150 enlarges and projects the color image formed on the display device 130 onto the screen S.

The illumination system 100 further includes a first light-path converter 120 which is disposed between the color separator 110 and the display device 130 and converts the path of an incident beam into a first direction; a second light-path converter 125 which converts the path of the beam reflected by the first light-path converter 120 into a second direction; and a condensing element 127 which directs the beam reflected by the second light-path converter 125 to the display device 130 and directs the beam reflected by the display device 130 toward the projection system 150.

The light source 103 is disposed under the cabinet 95 so that the optical axis of the light source 103 is parallel to a bottom surface of the cabinet 95. A beam, which is emitted from the light source 103 and proceeds parallel to the bottom surface of the light source 103, is reflected by the first light-path converter 120 upwards. In addition, the second light-path converter 125 directs the beam reflected by the first light-path converter 120 to the condensing element 127. The color separator 110 may be, for example, a color wheel.

An ultraviolet interception filter 105 is disposed on a light path between the light source 103 and the color separator 110, and an integrator 112, which shapes the beam emitted from the light source 103, is disposed between the color separator 110 and the first light-path converter 120. The integrator 112 shapes the beam so that the beam has a cross section corresponding to the shape of the display device 130.

Lenses for condensing beams are disposed on a light path between the integrator 112 and the condensing element 127. For example, a first condensing lens 114 is disposed between the integrator 112 and the first light-path converter 120. Second and third condensing lenses 115 and 116 are disposed between the first light-path converter 120 and the second light-path converter 125. A fourth condensing lens 117 is disposed between the second light-path converter 125 and the condensing element 127.

The condensing element 127 creates different optical paths for the beam incident on the display device 130 and the beam reflected by the display device 130. The condensing element 127 may be a total reflection prism having first and second prisms 127a and 127b opposite one another. The first prism 127a which is an incidence prism, totally reflects an incident beam directly to the display device 130, and the second prism 127b, which is an emission prism, transmits the beam reflected by the display device 130 directly to the projection system 150. Alternatively, the condensing element 127 may include a concave mirror or lens for condensing the beam from the second light-path converter 125 onto the display device 130.

The display device 130 may be a reflection type liquid crystal display (LCD) or a deformable micromirror device (DMD).

The projection system 150 includes a projection lens group 155 which makes a color image direct to a screen; and a reflection mirror 157 which directs the path of a beam properly.

In the present exemplary embodiment, the first light-path converter 120 which directs the beam emitted from the light source upwards so that the image forming apparatus can be suitably installed in the cabinet having a stand shape, and the second light-path converter 125 which makes the beam incident on the display device 130 at an optimum angle, are mounted.

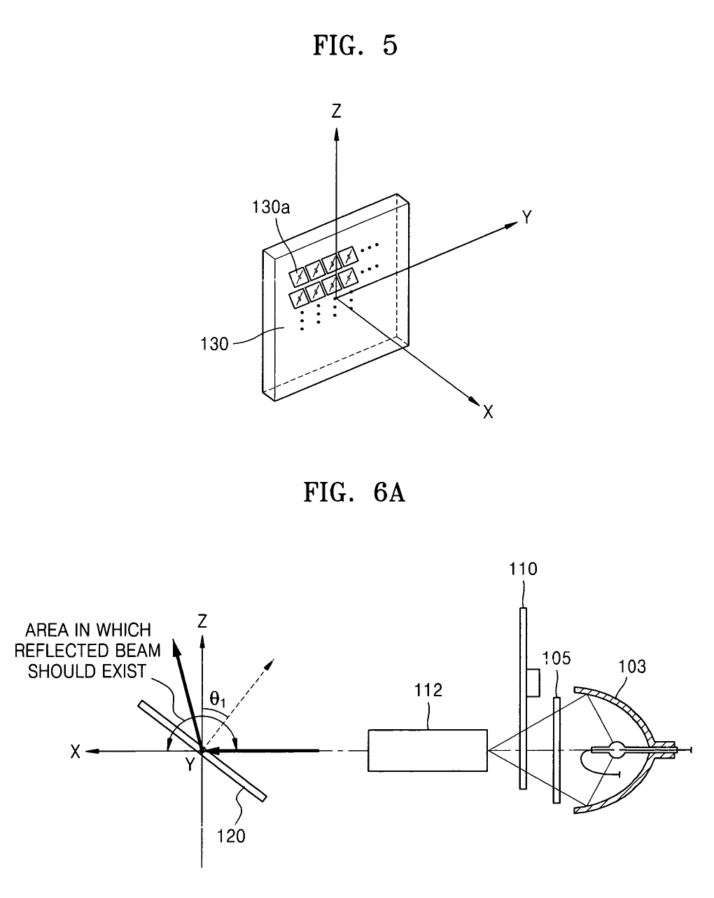

As shown in FIG. 5, in order to transfer the beam emitted from the light source 103 upwards, the first light-path converter 120 may be disposed at an angle which will be described later. In the DMD 130, a plurality of micromirrors 130a are arranged two-dimensionally, and the micromirrors 130a can be rotated separately. The incident beam proceeds toward the projection system 150 or deviates from the projection system 150 depending on the direction of the micromirrors 130a such that the incident beam is on-off in units of micromirrors.

Here, it is assumed that the direction perpendicular to the plane of the DMD 130 is the X-axis, the Z-axis is vertical and the Y-axis is defined by the conventions of a right-handed system. A coordinate system based on theses conventions is also used in FIG. 3.

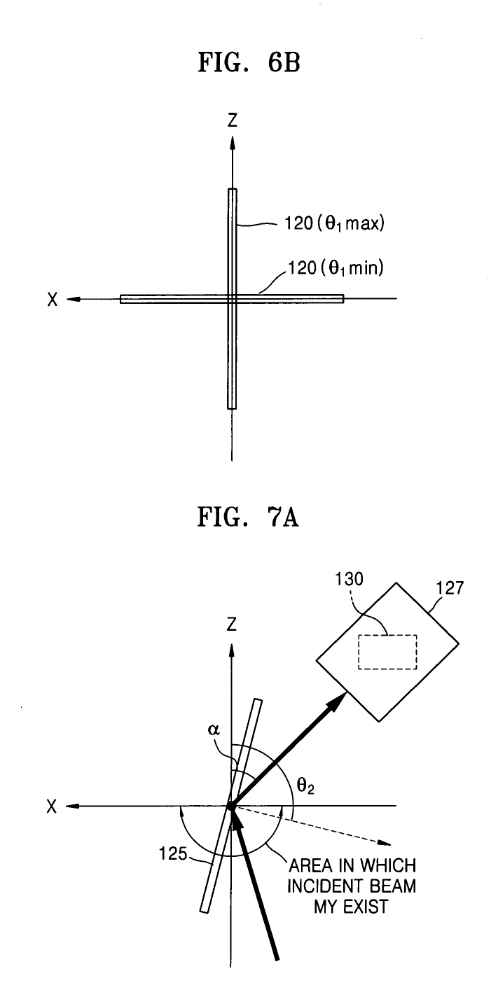

First, referring to FIG. 6A, in order to direct the beam reflected by the first light-path converter 120 upwards, an area in which the beam reflected by the first light-path converter 120 should exist, and that area should be in an upper part of the X-axis. For explanatory convenience, FIG. 6A shows a group of optical elements disposed on a path from the light source 103 to the first light-path converter 120.

In order to satisfy these conditions, the angle between the normal of the first light-path converter 120 and the Z-axis (θ 1) is between 0° and 90°. Referring to FIG. 6B, when the first light-path converter 120 is parallel to the X-axis, θ 1 has a minimum value ( θ 1 min) of 0, θ 1 min=0°. When the first light-path converter 120 is parallel to the Z-axis, θ 1 has a maximum value, θ 1 max=90°. The position of the first light-path converter 120, which transfers the beam emitted from the light source 103 upwards, is indicated by θ 1, and defined by relation 1.
0<θ₁<90 (°) (1)

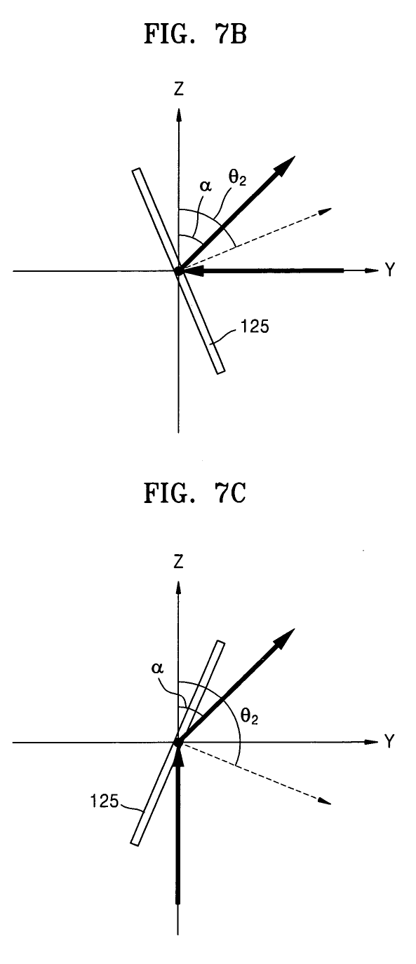

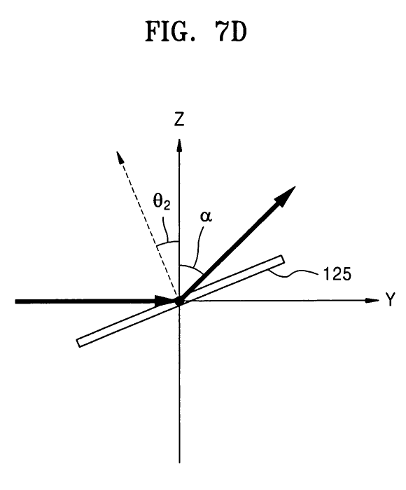

Next, referring to FIG. 7A, the beam reflected by the second light-path converter 125 is incident on the condensing element 127 at a predetermined angle α with respect to the Z-axis. In order to satisfy incident angle requirements, the gradient angle of the second light-path converter 125 is obtained as follows. That is, since the incident beam has been reflected by the first light-path converter 120 upwards, an area in which a beam incident on the second light-path converter 125 may exist, and that area is a lower portion of the X-Y plane.

Here, the beam reflected from the second light-path converter 125 has an angle α with respect to the Z-axis, and the angle between the Z-axis and normal of the second light-path converter 125 is referred to as θ2.

FIG. 7B shows the case where the beam incident on the second light-path converter 125 from the (+)Y-axis. In this case, θ2 is (45+α/2) degrees. FIG. 7C shows the case where the beam incident on the second light-path converter 125 is parallel to the Z-axis. In this case, θ2 is (90+α/2) degrees.

FIG. 7D shows the case where the beam incident on the second light-path converter 125 from the (−)Y-axis. In this case, θ2 is (45−α/2) degrees.

Referring to FIGS. 7B, 7C, and 7D, in order to direct the beam reflected by the second light-path converter 125 at an angle α with respect to the Z-axis, the following conditions may apply:

$$45 - \frac{α}{2} < {θ}_{2} < 90 + \frac{α}{2} ( ° ) \qquad ( 2 )$$

For example, when the display device 130 is a DMD, the beam reflected by the second light-path converter 125 is incident on the condensing element 127 at an angle of 45 degrees, with respect to the Z-axis, θ2 is given by relation 2.
22.5<θ₂<112.5 (°) (3)

Consistent with the present invention, a cabinet in which an illumination system and a projection system are received can extend in a lengthwise direction, and thus, the appearance of the image forming apparatus can be different from the appearance of a prior art image forming apparatus. In other words, the illumination system and the projection system can be easily mounted in a cabinet having a stand or pillar shape, as shown in FIG. 2.

Referring to FIG. 4, when a vertical distance from an arc center of the light source 103 to a plane parallel to the ground passing the center of the display device 130 is P and a horizontal distance from the arc center of the light source 103 to the first light-path converter 120 of the at least one light-path converter which is first placed on the light path from the light source 103 is Q, the ratio of Q to P may range from 1.5 to 2.0.

The illumination system 100 has the above structure and the illumination system 100 and the projection system 150 have a two-stage structure to be suitably mounted in a post-shaped cabinet.

As described above, in the image forming apparatus consistent with the present invention, the illumination system and the projection system for radiating beams are disposed to extend in a vertical direction and thus, can be easily mounted in a cabinet having a stand or pillar shape extending vertically.

Accordingly, the projection TV set having the image forming apparatus consistent with an exemplary embodiment of the present invention has a stand shape, so in the same, the projection TV set can have a variety of designs in order to satisfy customers' desires.

While the present invention has been particularly shown and described with reference to exemplary embodiments thereof, it will be understood by those skilled in the art that various changes in form and details may be made therein without departing from the spirit and scope of the invention as defined by the following claims.

1. An image forming apparatus comprising:
an illumination system comprising:
a light source;
a color separator separating beams irradiated from the light source into separate colored beams;
at least one light-path converter bending the beam irradiated from the light source upwards; and
a display device processing the incident beam in response to an input signal and forming a color image; and
a projection system enlarging and projecting the color image formed by the illumination system onto a screen,
wherein an optical axis of the beam emitted from the light source and an optical axis of the beam reflected by the display device are disposed by the at least one light-path converter at different heights such that the illumination system and the projection system extend to be narrow in a widthwise direction.

2. The image forming apparatus of claim 1, wherein the beam is emitted from the light source horizontally or vertically with respect to a ground.

3. The image forming apparatus of claim 1, wherein the display device is a deformable micromirror device (DMD).

4. The image forming apparatus of claim 1, wherein, if a vertical distance from a center of the light source to a plane parallel to a ground passing the center of the display device is P and a horizontal distance from the center of the light source to the first light-path converter of the at least one light-path converter which is first placed on the light path from the light source is Q, the ratio of Q to P ranges from 1.5 to 2.0.

5. A projection TV set comprising a screen unit and a cabinet having an image forming apparatus, wherein the image forming apparatus comprises:
an illumination system comprising:
a light source;
a color separator separating beams irradiated from the light source into separate colored beams;
at least one light-path converter bending the beam irradiated from the light source upwards; and
a display device processing the incident beam in response to an input signal and forming a color image; and
a projection system enlarging and projecting the color image formed by the illumination system onto a screen,
wherein an optical axis of the beam emitted from the light source and an optical axis of the beam reflected by the display device are disposed by the at least one light-path converter at different heights such that the illumination system and the projection system extend to be narrow in a widthwise direction.

6. The projection TV set of claim 5, wherein the beam is emitted from the light source horizontally or vertically with respect to a ground.

7. The projection TV set of claim 5, wherein the display device is a deformable micromirror device (DMD).

8. The projection TV set of claim 5, wherein, if a vertical distance from a center of the light source to a plane parallel to a ground passing the center of the display device is P and a horizontal distance from the center of the light source to the first light-path converter of the at least one light-path converter which is first placed on the light path from the light source is Q, the ratio of Q to P ranges from 1.5 to 2.0.
